(19) United States
(12) Patent Application Publication
(10) Pub. No.: US 2023/0194817 A1
(43) Pub. Date: Jun. 22, 2023

(54) OPTICAL FIBER CABLE WITH COIL ELEMENTS

(71) Applicant: Sterlite Technologies Limited, Gurugram (IN)

(72) Inventor: Vikash Shukla, Gurugram (IN)

(73) Assignee: Sterlite Technologies Limited, Gurugram (IN)

(21) Appl. No.: 17/697,682

(22) Filed: Mar. 17, 2022

(30) Foreign Application Priority Data
Dec. 21, 2021 (IN) 202111059613

(51) Int. Cl. G02B 6/44; G02B 6/02

(52) U.S. Cl. CPC G02B 6/4458; G02B 6/02042; G02B 6/02033

(57) ABSTRACT

An optical fiber cable with one or more coil elements is provided. The optical fiber cable (200, 300, 400) comprises one or more optical transmission elements (202, 302, 402) extending in a longitudinal direction surrounded by one or more coil elements (100). The one or more coil elements are a series of loops such that each loop (106) from the series of loops is physically connected to adjacent loops. The one or more coil elements are flexible in transverse direction and are substantially non-elongatable in the longitudinal direction. The one or more coil elements are fiber retaining element (102) such that subsequent loops (106) are made of a single continuous element and further comprises a pitch retaining element (104) connecting the subsequent loops of the fiber retaining element to preserve relative position of the subsequent loops.

### TECHNICAL FIELD

The present disclosure relates to optical fiber cables, and in particular, relates to optical fiber cable with coil elements.

### BACKGROUND

Optical fiber cables are a critical component of modern communications network across the globe. The optical fiber cables are typically made with or comprise loose tubes or buffer tubes. Conventionally, such tubes are made of PBT (Polybutylene terephthalate), PP (Polypropylene) and other similar materials that restrict easy bending of the optical fiber cables during handling and installation processes.

One way to address the aforesaid problem is to change the material of the tubes. However, the material change may not be a suitable option as it may result in additional manufacturing cost and reduced strength of the optical fiber cables. Another way to address the aforesaid problem is to change the design of the tubes. In the same context, a prior art reference “CN209590359” teaches a spiral tube used as a uni-tube in an optical fiber cable. Similarly, another prior art reference “JP2011150166A” discloses spiral tube body around a fiber in a cable connecting portion.

However, the designs proposed by the prior arts limited to uni-tube optical fiber cables and do not provide a solution to make multitube optical fiber cables. Thus, there exists a need to provide an alternative of the conventional tubes that are not limited to single type of cable design and also do not aid in increasing manufacturing cost of the optical fiber cables.

Any references to methods, apparatus or documents of the prior art are not to be taken as constituting any evidence or admission that they formed, or form part of the common general knowledge.

### SUMMARY

A primary object of the present disclosure is to provide an optical fiber cable with one or more coil elements. The one or more coil elements are a flexible alternative to conventional buffer or loose tubes to enclose one or more optical transmission elements.

Another object of the present disclosure is to provide the one or more coil elements with restricted elongation in longitudinal direction.

Accordingly, an optical fiber cable with one or more coil elements is provided. The optical fiber cable comprises one or more optical transmission elements extending in a longitudinal direction and one or more coil elements. The one or more coil elements are a series of loops such that each loop from the series of loops is physically connected to adjacent loops. The series of loops of the one or more coil elements surrounds the one or more optical transmission elements. The one or more coil elements are flexible in transverse direction and are substantially non-elongatable in the longitudinal direction. The optical fiber cable further comprises a central strength member, wherein the one or more coil elements are stranded around the central strength member and comprises at least one of a water swellable yarn and superabsorbent polymer powder inside the one or more coil elements. The one or more coil elements are fiber retaining elements such that subsequent loops are made of a single continuous element and further comprises a pitch retaining element connecting the subsequent loops of the fiber retaining element to preserve relative position of the subsequent loops. The one or more coil elements is defined by multiple subsequent loops placed at a predefined distance connected through a pitch retaining element longitudinally. A gap between two consecutive loops of the one or more coil elements is less than a width of a loop of the one or more coil elements. A distance between consecutive loops of the one or more coil elements varies up to d, where d is a gap between two consecutive loops in zero stress position during bending of the one or more coil elements to a circle of diameter equal to or more than 10 D, where D is an outer diameter of the one or more coil elements.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 illustrates a coil element for use in an optical fiber cable.

FIG. 2 illustrates an example uni-tube optical fiber cable with a coil element.

FIG. 3 illustrates an example multi-tube optical fiber cable with a plurality of coil elements.

FIG. 4 illustrates an example multi-tube optical fiber cable with the plurality of coil elements.

It should be noted that the accompanying figures are intended to present illustrations of few examples of the present disclosure. The figures are not intended to limit the scope of the present disclosure. It should also be noted that accompanying figures are not necessarily drawn to scale.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in details so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Unlike conventional tubes (such as buffer tube, loose tube) that restrict easy bending of optical fiber cables during handling and installation processes, the present disclosure proposes a coil element that is a flexible alternative to the conventional tubes to enclose one or more optical transmission elements. The coil element is flexible in transverse direction, thus can be bent easily as compared to the conventional tubes. Advantageously, the coil element makes handling and installation of the optical fiber cable flexible and easier. Further, the coil element uses less material as compared to the conventional tubes, thus making the optical fiber cable light-weight and cost-effective at the same time.

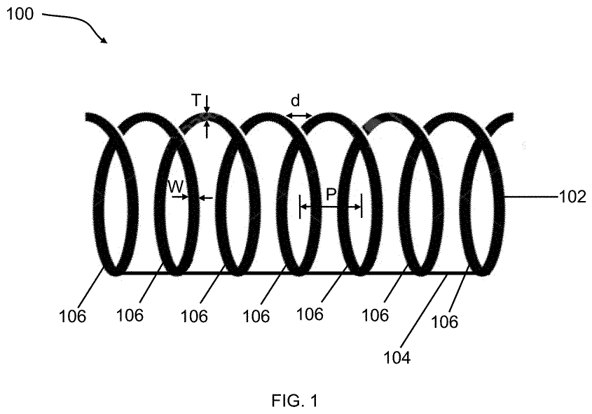

FIG. 1 illustrates a coil element 100 for use in an optical fiber cable. The coil element 100 may comprise of a fiber retaining element 102 such that subsequent loops 106 are made of a single continuous element. The coil element 100 may include a pitch retaining element 104 connecting the subsequent loops 106 of the fiber retaining element 102 to preserve relative position of the subsequent loops (or loops) 106. Thus, the coil element 100 may be defined as a series of loops such that each loop 106 is physically connected to adjacent loops 106. In other words, the coil element 100 may be defined as a series of connected loops. The coil element 100 may also be defined as multiple subsequent loops placed at a predefined distance connected through a longitudinal pitch retaining element (i.e., the pitch retaining element 104). The coil element 100 may be substantially non-elongatable in a longitudinal direction and flexible in a transverse direction during bending of the optical fiber cable. The coil element 100 may maintain a gap (d) between the series of loops during handling and installation of the optical fiber cable.

The fiber retaining element 102 may be characterized by the gap (d), a width (W), a thickness (T), a diameter and a pitch (P). The gap between two consecutive loops of the fiber retaining element 102 may be less than the width of a loop 106 of the fiber retaining element 102, so that the loops of the fiber retaining element 102 do not intermingle in the loops of another coil element when placed together. A distance between the consecutive loops of the fiber retaining element 102 may vary up to the gap (d) between two consecutive loops in zero stress position during bending of the coil element 100 in a circle of diameter equal to or more than 10 D, where D is an outer diameter of the coil element 100.

The width of the fiber retaining element 102 may be between 1 mm and 15 mm. Alternatively, the width may vary. Similarly, the thickness of the fiber retaining element 102 may be between 0.1 mm and 0.5 mm and the diameter of the fiber retaining element 102 may be between 1.5 mm and 9 mm to house optical transmission elements up to 576. The fiber retaining element 102 may be made of a single material, blend of more than one material or layers of one or more materials. Further, the pitch may be a distance between centres of two adjacent loops.

The series of loops may be equally sized and connected to each other in a spiral or helical fashion. Each of the series of loops of the coil element 100 may be substantially equal in size, shape and aligned with each other such that it projects a circular cross-sectional view like a hollow cylinder. The series of loops of the fiber retaining element 102 may have a radial deformation of less than 30% at an axial force of up to 50 N. Alternatively, the radial deformation may vary. Radial deformation may be defined as a change in diameter of the series of loops on applying the axial force and the axial force is a force applied in a longitudinal direction.

The pitch retaining element 104 may be made of a thermoplastic material and bond with the series of loops of the fiber retaining element 102 during extrusion. The pitch retaining element may be extruded in contact with an outer surface of the series of loops or through the series of loops. The series of loops and the pitch retaining element 104 may be fabricated in a tandem process. The pitch retaining element 104 may be characterized by a thickness. The thickness of the pitch retaining element 104 may be between 0.05 mm and 0.5 mm. Alternatively, the thickness of the pitch retaining element 104 may vary.

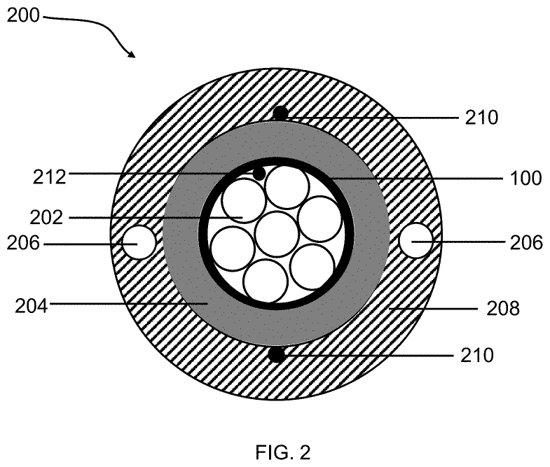

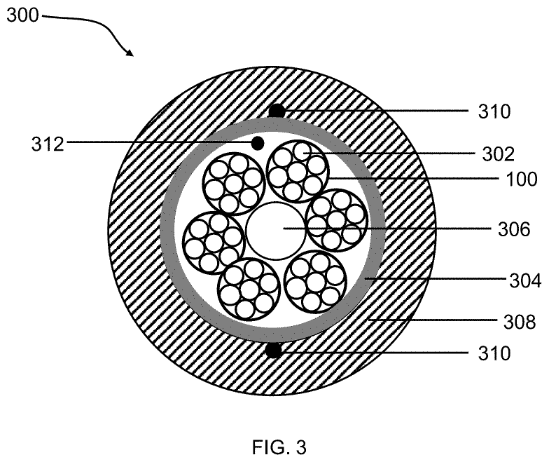

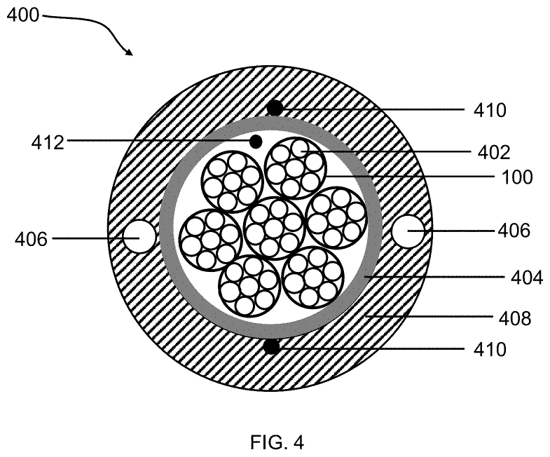

Now, simultaneous reference is made to FIG. 2 through FIG. 4, in which FIG. 2 illustrates an example uni-tube optical fiber cable 200 (Hereinafter referred to as optical fiber cable 200) with a coil element, FIG. 3 illustrates an example multi-tube optical fiber cable 300 (Hereinafter referred to as optical fiber cable 300) with a plurality of coil elements around a central strength member and FIG. 4 illustrates an example multi-tube optical fiber cable 400 (Hereinafter referred to as optical fiber cable 400) with the plurality of coil elements.

It may be noted that FIG. 2 through FIG. 4 have been shown to illustrate use/implementation of the coil element 100 and thus, the present disclosure is not limited to the designs of the optical fiber cable 200, 300, 400 shown in FIG. 2 through FIG. 4. It is possible to implement the coil element 100 in other various designs of the optical fiber cable.

The optical fiber cable 200, 300, 400 may comprise one or more optical transmission elements 202, 302, 402, one or more coil elements 100, a first layer 204, 304, 404 and a second layer 208, 308, 408.

The one or more optical transmission elements 202, 302, 402 may extend in a longitudinal direction. The one or more optical transmission elements (or interchangeably “optical fibers”) may be present in form of, but not limited to, a group of loose optical fibers, a group (or bundle) of optical fiber ribbons or a stack of optical fiber ribbons, a group of bendable ribbons, a group of corrugated ribbons, a group of partially bonded optical fiber ribbons, a group of flat ribbons. An optical fiber ribbon bundle is a group of a plurality of optical fiber ribbons arranged together. The optical fiber ribbon includes a number of optical fibers arranged together using a matrix material. Multiple individual optical fiber ribbons are stacked or grouped into a bundle to form the optical fiber ribbon bundle. Furthermore, a partially bonded optical fiber ribbon from the group of intermittently bonded optical fiber ribbons is formed by intermittently bonding the plurality of optical fibers with the matrix material that imparts a bending and rolling capability along a width of the partially bonded optical fiber ribbon.

Generally, an optical fiber refers to a medium associated with transmission of information over long distances in the form of light pulses. The optical fiber uses light to transmit voice and data communications over long distances when encapsulated in a jacket/sheath. The optical fiber may be of ITU.T G.657.A2 category. Alternatively, the optical fiber may be of ITU.T G.657.A1 or G.657.B3 or G.652.D or other suitable category. The ITU.T, stands for International Telecommunication Union-Telecommunication Standardization Sector, is one of the three sectors of the ITU. The ITU is the United Nations specialized agency in the field of telecommunications and is responsible for studying technical, operating and tariff questions and issuing recommendations on them with a view to standardizing telecommunications on a worldwide basis.

The optical fiber may be a bend insensitive fiber that has less degradation in optical properties or less increment in optical attenuation during bending of the optical fiber cable. Thus, the bend insensitive fiber further helps to maintain the optical properties during multiple winding/unwinding operations of the optical fiber cable. The optical fibers may be coloured fiber. The optical fiber may be a single-core optical fiber, a multi-core optical fiber, a single-mode optical fiber, a multimode optical fiber or the like. The single mode optical fiber carries only a single mode of light and the multimode optical fiber carries multiple modes of light to propagate. The multicore optical fibers comprise of multiple cores as opposed to the single-core optical fiber that comprise only a single core.

Referring back to FIG. 2, FIG. 3 and FIG. 4, a core of the optical fiber cable 200, 300, 400 may have a uni-tube/monotube design comprised of a single coil element (FIG. 2) or a multitube design comprised of multiple coil elements (FIG. 3 and FIG. 4) carrying the one or more optical transmission elements 202, 302, 402 respectively. That is, the one or more optical transmission elements 202, 302, 402 may be surrounded/enclosed by the one or more coil elements 100. The one or more coil elements 100 have already been explained in conjunction with FIG. 1. The one or more coil elements 100 may also contain at least one of a water swellable yarn 212, 312, 412 and superabsorbent polymer (SAP) powder (not shown).

Further, the optical fiber cable 200, 300, 400 may or may not comprise a central strength member. In the presence of the central strength member 306, the one or more coil elements 100 may be stranded around the central strength member 306 (as shown in FIG. 3). The stranding may be helical or SZ. A helical stranding is performed either clockwise or anti-clockwise. In SZ stranding, a number of turns are wound in S direction and then a number of turns in Z direction throughout the length. The central strength member 306 may be made of, but not limited to, FRP (Fiber Reinforced Plastic), ARP (Aramid Reinforced Plastic) or any other suitable dielectric/strength material. The central strength member 306 may have a round shape, a flat shape or any other suitable shape. Alternatively, the optical fiber cable may comprise one or more strength members 206, 406 embedded in the second layer 208, 408 as shown in FIG. 2 and FIG. 4. The one or more strength members 206, 406 may be made of, but not limited to, FRP (Fiber Reinforced Plastic), ARP (Aramid Reinforced Plastic) or any other suitable dielectric/strength material. The one or more strength members 206, 406 may have a round shape, a flat shape or any other suitable shape. The one or more strength members 206, 406 may be coated with EAA (Ethylene Acrylic Acid) or EVA (Ethylene-Vinyl Acetate) coating for better adhesion with the second layer 208, 408, i.e., to enhance the adhesion of the one or more strength members 206, 406 with the second layer 208, 408.

The one or more coil elements 100 may be encapsulated by the first layer 204, 304, 404. The first layer 204, 304, 404 may be, but not limited to, water blocking tape, metal tape, dielectric armouring.

The first layer 204, 304, 404 may be encapsulated by the second layer 208, 308, 408. The second layer 208, 308, 408 may be a sheath or jacket formed by, but not limited to, polyvinylchloride, polyethylene (such as High Density Poly Ethylene (HDPE), Medium Density Poly Ethylene, and Low Density Poly Ethylene), polyurethane, thermoplastic rubber/elastomer, thermoplastic chlorinated polyethylene or combination thereof. It may be noted that only two layers i.e., first layer and second layer have been represented as an example, the optical fiber cable 200, 300, 400 may contain one or more layers depending upon requirement and implementation. Non-limiting examples of the one or more layers may be water blocking tape, metal tape, dielectric armouring, yarns etc.

The optical fiber cable 200, 300, 400 may also contain one or more rip cords 210, 310, 410. The one or more rip cords 210, 310, 410 may be provided in the second layer 208, 308, 408 or in between the first layer 204, 304, 404 and the second layer 208, 308, 408. The one or more rip cords 210, 310, 410 may facilitate easy stripping of the optical fiber cable 200, 300, 400 and may be made of nylon, polyester, aramid yarns or any other suitable material and may have a flat shape, monochord, cabled structure or any other suitable structure depending upon the requirement of the optical fiber cable.

It will be apparent to those skilled in the art that other alternatives of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific aspect, method, and examples herein. The invention should therefore not be limited by the above described alternative, method, and examples, but by all aspects and methods within the scope of the invention. It is intended that the specification and examples be considered as exemplary, with the true scope of the invention being indicated by the claims.

Conditional language used herein, such as, among others, “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. An optical fiber cable (200, 300, 400), comprising:
one or more optical transmission elements (202, 302, 402) extending in a longitudinal direction; and
one or more coil elements (100),
wherein the one or more coil elements are a series of loops such that each loop (106) from the series of loops is physically connected to adjacent loops, wherein the series of loops of the one or more coil elements (100) surrounds the one or more optical transmission elements (202, 302, 402), wherein the one or more coil elements (100) are flexible in transverse direction.

2. The optical fiber cable (200, 300, 400) as claimed in claim 1, wherein the one or more coil elements (100) are substantially non-elongatable in the longitudinal direction.

3. The optical fiber cable (200, 300, 400) as claimed in claim 1, wherein the series of loops has a radial deformation of less than 30% at an axial force of up to 50 N.

4. The optical fiber cable (200, 300, 400) as claimed in claim 1, wherein a distance between consecutive loops of the one or more coil elements (100) varies up to d, where d is a gap between two consecutive loops in zero stress position, during bending of the one or more coil elements (100) to a circle of diameter equal to or more than 10 D, where D is an outer diameter of the one or more coil elements (100).

5. The optical fiber cable (200, 300, 400) as claimed in claim 1, wherein the one or more coil elements (100) are made of a fiber retaining element (102) such that subsequent loops (106) are made of a single continuous element.

6. The optical fiber cable (200, 300, 400) as claimed in claim 5, wherein the one or more coil elements (100) further comprises a pitch retaining element (104) connecting the subsequent loops (106) of the fiber retaining element (102) to preserve relative position of the subsequent loops.

7. The optical fiber cable (200, 300, 400) as claimed in claim 1, wherein the one or more coil elements (100) is defined by multiple subsequent loops placed at a predefined distance connected through a pitch retaining element (104) longitudinally.

8. The optical fiber cable (200, 300, 400) as claimed in claim 1, wherein the optical fiber cable (300) further comprises a central strength member (306), wherein the one or more coil elements (100) are stranded around the central strength member (306).

9. The optical fiber cable (200, 300, 400) as claimed in claim 1, wherein a gap between two consecutive loops of the one or more coil elements (100) is less than a width of a loop (106) of the one or more coil elements (100).

10. The optical fiber cable (200, 300, 400) as claimed in claim 1 further comprising at least one of a water swellable yarn (212, 312, 412) and superabsorbent polymer powder in the one or more coil elements (100).
